(19) United States
(12) Patent Application Publication
(10) Pub. No.: US 2020/0230010 A1
(43) Pub. Date: Jul. 23, 2020

(54) OPERATING TABLE

(71) Applicant: TRUMPF MEDIZIN SYSTEME GMBH + CO. KG, Saalfeld (DE)

(72) Inventor: Tong ZHAO, Saalfeld (DE)

(21) Appl. No.: 16/745,677

(22) Filed: Jan. 17, 2020

(30) Foreign Application Priority Data
Jan. 18, 2019 (EP) 19152616.9

(51) Int. Cl. A61G 13/12

(52) U.S. Cl. CPC A61G 13/126

(57) ABSTRACT

An operating table comprises a table panel, a pad covering at least a portion of an upper face of the table panel, and a micro suction foil configured to be sandwiched between the upper face of the table panel and the pad to attach the pad to the upper face of the table panel.

### CROSS-REFERENCE TO RELATED APPLICATIONS

This application claims the benefit of European Patent Application Serial No. 19152616.9, filed on Jan. 18, 2019, the entire disclosure of which is incorporated herein by reference in its entirety.

### TECHNICAL FIELD

An operating table comprises a table panel, a pad covering at least a portion of an upper face of the table panel, and a micro suction foil configured to be sandwiched between the upper face of the table panel and the pad to attach the pad to the upper face of the table panel.

### BACKGROUND

Hitherto, hook and loop fasteners, i.e., so-called Velcro® fasteners, have been widely used for fixing detachable pads on a table panel of an operating table since such a fixing is quite reliable and, furthermore, it can be unfixed.

However, these hook and loop fasteners include the disadvantage that they are difficult to clean and, therefore, a hygiene issue exists since germs and bacteria can be included in these fasteners. Other solutions to replace the hook and loop fasteners are mushroom shaped fixation knobs or sticky tapes. However, in case of the mushroom shaped fixation knobs, there is a risk of pressure ulcer and the sticky tapes collect dirt and, therefore, there is also a hygiene issue. As another solution, so-called anti-slip pads have been used, however, these pads do not actually fix the pads of the surgical table but only slightly increase the friction between the pads and the table panel.

Therefore, the object underlying the present disclosure is to provide an operating table having a fixing device to fix a pad on a table panel of the operating table which eliminates the above-mentioned disadvantages and which forms a reliable fixing which is easy to handle and does not create hygiene issues.

### SUMMARY

The present disclosure includes one or more of the features recited in the appended claims and/or the following features which, alone or in any combination, may comprise patentable subject matter.

According to an aspect of the present disclosure, an operating table comprises a table panel, a pad covering at least a portion of an upper face of the table panel, and a micro suction foil configured to be sandwiched between the upper face of the table panel and the pad to attach the pad to the upper face of the table panel.

The micro suction foil has micro suction surfaces functioning as a huge quantity of suction cups which do not have a sticky characteristic. The micro suction foil is easy to clean and to disinfect and, when provided with an area which is large enough, it provides a sufficient holding force between the table panel and the pad.

In an embodiment of the operating table, the micro suction foil has both sides provided with the micro suction surface, and the upper face of the table panel contacting the micro suction foil has a surface structure configured to reduce a holding force between the upper face of the table panel and the micro suction foil such that the holding force between the pad and the micro suction foil is larger than between the upper face of the table panel and the micro suction foil.

By these characteristics, the micro suction foil can be attached to and removed from the table panel and the pad and, therefore, intensive cleaning and disinfecting of the pad and of the table panel is possible, wherein, afterwards, the micro suction foil can be used again. In order to define the assignment of the micro suction foil to the pad, the holding forces are adjusted such that, when removing the pad from the table panel, the micro suction foil rests on the pad so that the pad can also be used for another table panel without any fixing means.

In another embodiment of the operating table, the micro suction foil has both sides provided with a micro suction surface, and a face of the pad contacting the micro suction foil has a surface structure configured to reduce a holding force between the face of the pad and the micro suction foil such that the holding force between the pad and the micro suction foil is smaller than between the upper face of the table panel and the micro suction foil.

By these characteristics, the micro suction foil can be attached to and removed from the table panel and the pad and, therefore, intensive cleaning and disinfecting of the pad and of the table panel is possible, wherein, afterwards, the micro suction foil can be used again. In order to define the assignment of the micro suction foil to the table panel, the holding forces are adjusted such that the micro suction foil rests on the table panel so that another pad without any fixing means can also be used with the operating table.

In a further embodiment of the operating table, the micro suction foil comprises a side provided with a sticky surface and another side provided with a micro suction surface, and the micro suction foil is attached to the pad by means of the sticky surface.

Due to this fixing by the sticky surface, the micro suction foil is fixedly assigned to the pad so that the pad is always provided with the fixing means and a pad can be attached independently from a presence of a fixing means on the table panel.

In another embodiment of the operating table, the micro suction foil comprises of a sticky surface on one side and a micro suction surface on the other. The micro suction foil is attached to the upper face of the table panel by means of the sticky surface.

Due to this fixing by the sticky surface, the micro suction foil is fixedly assigned to the table panel so that the table panel is always provided with the fixing means and a pad can be attached independently from a presence of a fixing means on the pad.

In a further embodiment of the operating table, the micro suction foil is configured to cover an entire upper face of the table panel and the face of the pad facing each other which is larger than the other one.

When covering the larger one of the entire face, an attachment area is as large as possible so that a holding force is large. Nevertheless, the pad can easily be removed when bending the pad so that the fixing is unfixed in a rolling line contact.

In a further embodiment of the operating table, the micro suction foil is configured to cover a portion of the upper face of the table panel or of a face of the pad facing the other one of the face of the pad and the upper face of the table panel.

By this configuration, the amount of the micro suction foil can be saved so that the minimum required holding force is ensured and costs and mounting efforts are reduced.

In a further embodiment of the operating table, the micro suction foil is configured as a micro suction tape, and the micro suction tape is attached to the pad or to the upper face of the table panel in an edge region thereof.

By the attachment in an edge region of the pad or the table panel, except from saving the amount of the micro suction foil, a safe fixing and orientation of the pad with respect to the table panel is ensured.

In a further embodiment of the operating table, the micro suction foil is configured as a micro suction tape, and the micro suction tape is attached to the pad or to the upper face of the table panel in an central region thereof.

Due to the fixing in the central area of the pad or of the table panel, except from saving the amount of the micro suction foil, the pad can easily be deformed when loaded by a patient so that a flexibility of the pad is enhanced.

In a further embodiment of the operating table, a further micro suction foil configured to be sandwiched between the micro suction foil and the upper face of the table panel or the pad is provided to attach the pad to the upper face of the table panel. The further micro suction foil at least partially overlaps the micro suction foil.

By the provision of the further micro suction foil at least partially overlapping the micro suction foil, the holding force is increased.

In a further embodiment of the operating table, the operating table further comprises a liquid barrier configured to prevent ingress of a liquid between the micro suction foil and an upper face of the table panel contacting the micro suction foil or a face of the pad contacting the micro suction foil.

A characteristic of the micro suction foil is that it loses holding force when being wet also in a case when the pad is already attached to the table panel due to a capillary effect. Therefore providing the liquid barrier prevents the loss of the holding force.

In a further embodiment of the operating table, the liquid barrier is formed as a labyrinth seal.

A labyrinth seal, e.g., in the form of a downwardly projecting edge of the pad adjacent to an edge of the table panel, is an easy measure for providing a liquid tightness.

In a further embodiment of the operating table, the liquid barrier is formed as a sealing lip.

A sealing lip, e.g., in the form of a downwardly projecting edge of the pad contacting the upper face of the table panel, is an easy measure for providing a liquid tightness.

In a further embodiment of the operating table, the liquid barrier is formed as slits through the table panel in predetermined distances from edges of the table panel, the predetermined distances being defined such that the slits are located between the edges of the table panel and the micro suction foil attached to the table panel.

By the slits, liquid intruded between the table panel and the pad can be drained so that it does not reach the micro suction foil in order to prevent loss of the holding force.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 shows an operating table according to an embodiment of the present disclosure;

FIG. 2A shows a principle side view of an embodiment of a micro suction foil having one side provided with a sticky surface and another side provided with a micro suction surface;

FIG. 2B shows a principle side view of another embodiment of the micro suction foil having both sides provided with a micro suction surface;

FIG. 3A shows a principle plan view of a pad of the operating table provided with micro suction foils in edge regions thereof;

FIG. 3B shows a principle plan view of the pad of the operating table provided with micro suction foils in a central region thereof;

FIG. 3C shows a principle plan view of the pad of the operating table, an entire face thereof is covered with a micro suction foil;

FIG. 4A shows a principle side view of a portion of the operating table having a labyrinth seal as a liquid barrier;

FIG. 4B shows a principle side view of a portion of the operating table having a sealing lip as the liquid barrier, and

FIG. 4C shows a principle side view of a portion of the operating table having a slit as the liquid barrier.

### DETAILED DESCRIPTION OF THE DRAWINGS

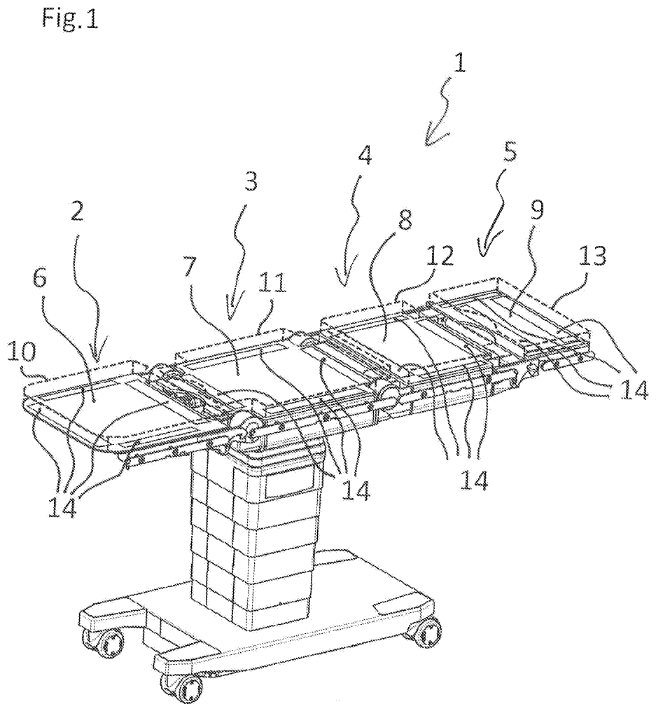

FIG. 1 shows an operating table 1 according to an embodiment of the present disclosure. The operating table 1 comprises several sections 2, 3, 4, 5. Each of the sections 2, 3, 4, 5 respectively comprises a table panel 6, 7, 8, 9 and a pad 10, 11, 12, 13. For sake of clarity, the pads 10, 11, 12, 13 are illustrated by dashed lines. Each pad 10, 11, 12, 13 covers an upper face of the table panels 6, 7, 8, 9. In an alternative embodiment, the operating table is provided with one single table panel and one of the pads covers at least a portion of the upper face thereof.

The operating table 1 further comprises micro suction foils 14 in the form of micro suction tapes. The micro suction foils 14 are formed, at least on one side, by, e.g. microscopic craters in its surface functioning like micro suction cups. Therefore, they stick to smooth surfaces without any bonding agent. As one illustrative example, a micro suction foil may be embodied as “REGABOND-S” non-slip temporary fixation material available from Exel Trading Co., Ltd. of Tokyo, Japan. The micro suction foils 14 attach the pads 10, 11, 12, 13 to the upper faces of the table panels 6, 7, 8, 9. In FIG. 1, each of the pads 10, 11, 12, 13 is attached to the respective table panel 6, 7, 8, 9 by four micro suction tapes, however, in alternative embodiments, another suitable quantity of micro suction tapes or micro suction foils is provided.

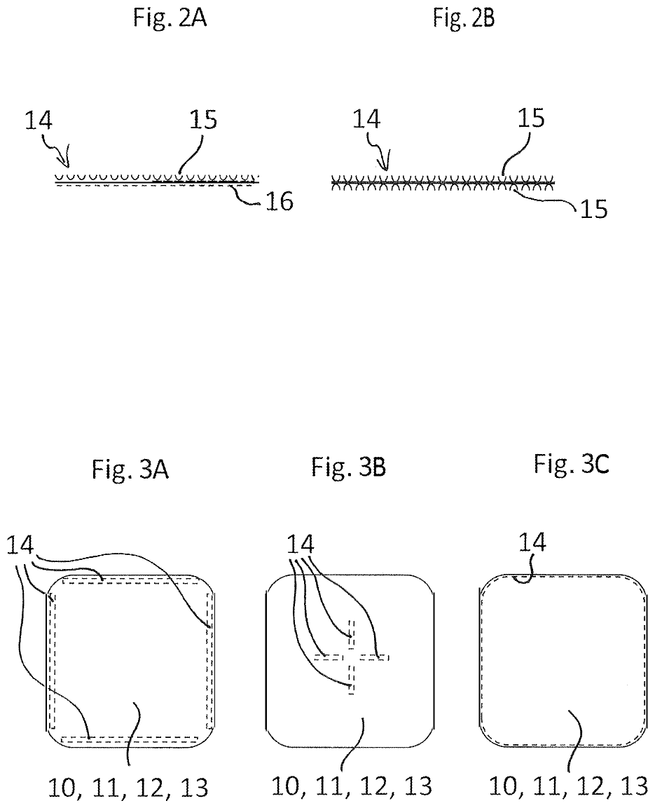

FIG. 2A shows a principle side view of the micro suction foil 14 having one side provided with a micro suction surface 15 and another side provided with a sticky surface 16. The sticky surface 16 is formed by applying a bonding agent on one side of the micro suction foil 14. Back to FIG. 1, the micro suction foils 14 are respectively attached to the pads 10, 11, 12, 13 by means of the sticky surfaces 16. Alternatively, the micro suction foils 14 are attached to the upper faces of the table panels 6, 7, 8, 9 by means of the sticky surfaces 16.

FIG. 2B shows a principle side view of the micro suction foil 14 having both sides provided with the micro suction surface 15. Back to FIG. 1, an alternative embodiment of the operating table 1 is provided with the micro suction foils 14 having both sides provided with the micro suction surface 15. The upper faces of the table panels 6, 7, 8, 9 contacting the micro suction foils 14 have surface structures reducing a holding force between the upper faces of the table panels 6, 7, 8, 9 and the micro suction foils 14. Therefore, the holding force between the pads 10, 11, 12, 13 and the micro suction foils 14 is larger than between the upper faces of the table panels 6, 7, 8, 9 and the micro suction foils 14.

In a further alternative embodiment of the operating table 1, the micro suction foil 14 has both sides provided with the micro suction surface 15, and the faces of the pads 10, 11, 12, 13 contacting the micro suction foils 1 have surface structures reducing a holding force between the faces of the pads 10, 11, 12, 13 and the micro suction foils 14 such that the holding forces between the pads 10, 11, 12, 13 and the micro suction foil 14 are smaller than between the upper faces of the table panels 6, 7, 8, 9 and the micro suction foils 14.

FIG. 3A shows a principle plan view of one of the pads 10, 11, 12, 13 provided with the micro suction foils 14 in the form of the micro suction tapes attached to the pads 10, 11, 12, 13 in edge regions thereof. Alternatively, the micro suction foils 14 are attached to the table panels 6, 7, 8, 9 at corresponding locations of the edge regions. Therefore, the micro suction foils 14 are configured to cover a portion of the upper faces of the table panels 6, 7, 8, 9 or of the faces of the pads 10, 11, 12, 13 facing the other one of the faces of the pad 10, 11, 12, 13 and the upper faces of the table panels 6, 7, 8, 9.

FIG. 3B shows a principle plan view of one of the pads 10, 11, 12, 13 provided with the micro suction foils 14 in the form of the micro suction tapes attached to the pads 10, 11, 12, 13 in a central region thereof. Alternatively, the micro suction foils 14 are attached to the table panels 6, 7, 8, 9 at corresponding locations of the central region. Therefore, also in this case, the micro suction foils 14 are configured to cover a portion of the upper faces of the table panels 6, 7, 8, 9 or of the faces of the pads 10, 11, 12, 13 facing the other ones of the faces of the pads 10, 11, 12, 13 and the upper faces of the table panels 6, 7, 8, 9.

FIG. 3C shows a principle plan view of one of the pads 10, 11, 12, 13, an entire face thereof is covered with the micro suction foil 14. Even though the edge of the micro suction foil 14 illustrated by a dashed line is illustrated spaced from an outer edge of the pad 10, 11, 12, 13, actually, the micro suction foil 14 at least almost covers the entire face of the pad 10, 11, 12, 13. Alternatively, the micro suction foils 14 are attached to the table panels 6, 7, 8, 9 in a corresponding size. Therefore, the micro suction foil 14 is configured to cover an entire upper face of the table panels 6, 7, 8, 9 or of a face of the pads 10, 11, 12, 13 facing the other one of the face of the pads 10, 11, 12, 13 and the upper face of the table panels 6, 7, 8, 9.

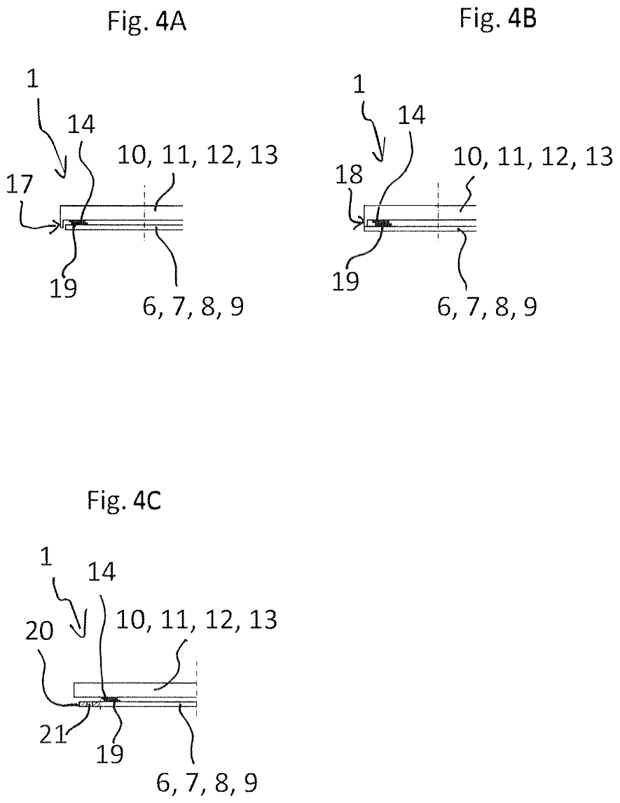

FIG. 4A shows a principle side view of a portion of the operating table 1 having a labyrinth seal 17 as a liquid barrier to prevent ingress of a liquid between the micro suction foil 14 and an upper face of the table panels 6, 7, 8, 9 contacting the micro suction foil 14 or a face of the pads 10, 11, 12, 13 contacting the micro suction foil 14. The labyrinth seal 17 functions by elongation of a flowpath through a gap to be sealed.

FIG. 4B shows a principle side view of a portion of the operating table 1 having a sealing lip 18 on the pad 10, 11, 12, 13 as the liquid barrier to prevent ingress of a liquid between the micro suction foil 14 and an upper face of the table panels 6, 7, 8, 9 contacting the micro suction foil 14 or a face of the pads 10, 11, 12, 13 contacting the micro suction foil 14. Alternatively, the sealing lip is provided on the upper face of the table panels 6, 7, 8, 9.

FIG. 4C shows a principle side view of a portion of the operating table having a slit 21 as the liquid barrier.

The liquid barrier is formed as slits 21 through the table panel 6, 7, 8, 9 in predetermined distances from edges 20 of the table panel 6, 7, 8, 9. The predetermined distances are defined such that the slits 21 are located between the edges 20 of the table panel 6, 7, 8, 9 and the micro suction foil 14 attached to the table panel 6, 7, 8, 9.

In further alternative embodiments, other liquid barriers, as, e.g. caulking strips, are provided for preventing ingress of a liquid between the micro suction foil 14 and an upper face of the table panels 6, 7, 8, 9 contacting the micro suction foil 14 or a face of the pads 10, 11, 12, 13 contacting the micro suction foil 14.

Moreover, FIG. 4A, 4B and 4C show a further micro suction foil 19 configured to be sandwiched between the micro suction foil 14 and the upper face of the table panel 6, 7, 8, 9 to attach the pad 10, 11, 12, 13 to the upper face of the table panel 6, 7, 8, 9. The further micro suction foil 19 at least partially overlaps the micro suction foil 14. In an alternative embodiment, the further micro suction foil 19 is sandwiched between the micro suction foil 14 and the pad 10, 11, 12, 13.

While the present disclosure has been illustrated and described in detail in the drawings and the foregoing description, such illustration and description are to be considered illustrative and not restrictive. The invention is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

Although this disclosure refers to specific embodiments, it will be understood by those skilled in the art that various changes in form and detail may be made without departing from the subject matter set forth in the accompanying claims.

1. An operating table comprising:
a table panel,
a pad covering at least a portion of an upper face of the table panel, and
a micro suction foil configured to be sandwiched between the upper face of the table panel and the pad to attach the pad to the upper face of the table panel.

2. The operating table of claim 1, wherein the micro suction foil has both sides provided with a micro suction surface, and the upper face of the table panel contacting the micro suction foil has a surface structure configured to reduce a holding force between the upper face of the table panel and the micro suction foil such that the holding force between the pad and the micro suction foil is larger than between the upper face of the table panel and the micro suction foil.

3. The operating table of claim 1, wherein the micro suction foil has both sides provided with a micro suction surface, and a face of the pad contacting the micro suction foil has a surface structure configured to reduce a holding force between the face of the pad and the micro suction foil such that the holding force between the pad and the micro suction foil is smaller than between the upper face of the table panel and the micro suction foil.

4. The operating table of claim 1, wherein the micro suction foil comprises a side provided with a sticky surface and another side provided with a micro suction surface, and the micro suction foil is attached to the pad by means of the sticky surface.

5. The operating table of claim 1, wherein the micro suction foil comprises one side provided with a sticky surface and another side provided with a micro suction surface, and the micro suction foil is attached to the upper face of the table panel by means of the sticky surface.

6. The operating table of claim 1, wherein the micro suction foil is configured to cover an entire one of the upper face of the table panel and the face of the pad facing each other which is larger than the other one.

7. The operating table of anyone of claim 1, wherein the micro suction foil is configured to cover a portion of the upper face of the table panel or of a face of the pad facing the other one of the face of the pad and the upper face of the table panel .

8. The operating table of claim 7, wherein the micro suction foil is configured as a micro suction tape, and the micro suction tape is attached to the pad or to the upper face of the table panel in an edge region thereof.

9. The operating table of claim 7, wherein the micro suction foil is configured as a micro suction tape, and the micro suction tape is attached to the pad or to the upper face of the table panel in a central region thereof.

10. The operating table of claim 1, further comprising a second micro suction foil configured to be sandwiched between the first micro suction foil and the upper face of the table panel or the pad to attach the pad to the upper face of the table panel, the second micro suction foil at least partially overlapping the first micro suction foil .

11. The operating table of claim 1, wherein the operating table further comprises a liquid barrier configured to prevent ingress of a liquid between the micro suction foil and an upper face of the table panel contacting the micro suction foil or a face of the pad contacting the micro suction foil .

12. The operating table of claim 11, wherein the liquid barrier is formed as a labyrinth seal.

13. The operating table of claim 11, wherein the liquid barrier is formed as a sealing lip.

14. The operating table of claim 11, wherein the liquid barrier is formed as slits through the table panel in predetermined distances from edges of the table panel, the predetermined distances being defined such that the slits are located between the edges and the micro suction foil attached to the table panel.

15. The operating table of claim 1, wherein the micro suction foil comprises microscopic craters in its surface functioning like micro suction cups.

16. A pad for an operating table, the pad comprising
a cover defining a first planar surface, and
a micro suction foil secured the first planar surface, the micro suction foil pad having a first surface engaged with the first planar surface of the cover to releasably secure the micro suction foil to the first planar surface, the micro suction foil having a second surface opposite the first surface, the second surface configured to engage a panel of an operating table to secure the pad to the panel of the operating table.

17. The pad of claim 16, wherein the micro suction foil comprises a side provided with a sticky surface and another side provided with a micro suction surface, and the micro suction foil is attached to the pad by means of the sticky surface.

18. The pad of claim 16, wherein the micro suction foil comprises microscopic craters in its surface functioning like micro suction cups.

19. The pad of claim 16, wherein the micro suction foil is configured such that the holding force of the micro suction foil to the planar surface of the cover is greater than the holding force of the micro suction foil to a panel of an operating table.

20. The pad of claim 19, wherein the micro suction foil comprises microscopic craters on both the first and second surface of the micro suction foil.
